(19) United States
(12) Patent Application Publication
(10) Pub. No.: US 2019/0272473 A1
(43) Pub. Date: Sep. 5, 2019

(54) TIME VARIANT RIPENESS RECOMMENDATION

(71) Applicant: International Business Machines Corporation, Armonk, NY (US)

(72) Inventors: Lori L. Adington, Raleigh, NC (US); Dana L. Price, Surf City, NC (US); Eduardo M. Breijo Baullosa, Morrisville, NC (US); Mary A. Curran, Apex, NC (US)

(21) Appl. No.: 15/911,019

(22) Filed: Mar. 2, 2018

(51) Int. Cl. G06N 7/00; G06Q 30/06

(52) U.S. Cl. CPC G06N 7/005; G06Q 30/0633

(57) ABSTRACT

A plurality of recipes containing a plurality of produce items can be assigned a preparation day. The plurality of produce items comprised in the plurality of recipes are partitioned into an interactive grocery list. Each item of the plurality of produce items comprised in the interactive grocery list is assigned a calculated reference identifier. Calculated reference identifiers are transferred to a user device and recommend the highest probability of produce ripeness with consideration to the assigned preparation day.

### BACKGROUND

The present invention relates to cognitive computing and more specifically, recommendations using ripening pattern analytics.

### SUMMARY

Aspects of the present disclosure are directed to a method for providing produce recommendations to a user. The method can comprise receiving a preparation day for each recipe comprised in a plurality of selected recipes. The method can further comprise receiving respective preferences for a plurality of produce comprised in the plurality of selected recipes and then partitioning an interactive grocery list. The method can further comprise calculating respective reference identifiers for single and repeated produce items extracted from the plurality of selected recipes, where each repeated produce items are presented with different respective reference identifiers. The method can then output the calculated reference identifiers to a user device, where each respective reference identifier comprises a specific visual representation and recommended qualitative description of the condition of corresponding produce that will have the highest probability to achieve ripeness considering an estimated number of days before use.

Aspects of the present disclosure are directed to a system comprising a computer readable storage medium storing a corpus of data, a user interface configured to receive input and present output and a processor communicatively coupled to the computer readable storage medium and the user interface and having a memory comprising instructions. The instructions can be configured to provide produce recommendations to a user. The instructions can be further configured to receive a preparation day for each recipe comprised in a plurality of selected recipes. The instructions can further be configured to receive respective preferences for a plurality of produce comprised in the plurality of selected recipes and then partitioning an interactive grocery list. The instructions can further be configured calculate respective reference identifiers for single and repeated produce items extracted from the plurality of selected recipes, where each repeated produce items are presented with different respective reference identifiers. The instructions can then output the calculated reference identifiers to a user device, where each respective reference identifier comprises a specific visual representation and recommended qualitative description of the condition of corresponding produce that will have the highest probability to achieve ripeness considering an estimated number of days before use.

Aspects of the present disclosure are further directed to a computer program product for providing produce recommendation, the computer program product comprising a computer readable storage medium having program instructions embodied therewith, the program instructions executable by a processor. The program instructions can cause the processor to provide produce recommendations to a user. The program instructions can further cause the processor to receive a preparation day for each recipe comprised in a plurality of selected recipes. The program instructions can further cause the processor to receive respective preferences for a plurality of produce comprised in the plurality of selected recipes and then partitioning an interactive grocery list. The program instructions can further cause the processor to calculate respective reference identifiers for single and repeated produce items extracted from the plurality of selected recipes, where each repeated produce items are presented with different respective reference identifiers. The processor can then output the calculated reference identifiers to a user device, where each respective reference identifier comprises a specific visual representation and recommended qualitative description of the condition of corresponding produce that will have the highest probability to achieve ripeness considering an estimated number of days before use.

### BRIEF DESCRIPTION OF THE DRAWINGS

The drawings included in the present application are incorporated into, and form part of, the specification. They illustrate embodiments of the present disclosure and, along with the description, explain the principles of the disclosure. The drawings are only illustrative of certain embodiments and do not limit the disclosure.

FIG. 1 illustrates a flowchart of an example method for providing recommendations using ripening pattern analytics in accordance with some embodiments of the present disclosure.

FIG. 2 illustrates a block diagram of an example Internet of Things (IoT) environment in accordance with some embodiments of the present disclosure.

FIG. 3 illustrates a flowchart of an example method for condition identification with regard to time in accordance with some embodiments of the present disclosure.

FIG. 4 illustrates a block diagram of an example ripeness recommendation system in accordance with some embodiments of the present disclosure.

FIG. 5 depicts a cloud computing environment according to an embodiment of the present invention.

FIG. 6 depicts abstraction model layers according to an embodiment of the present invention.

While the present disclosure is amendable to various modifications and alternative forms, specifics thereof have been shown by way of example in the drawings and will be described in detail. It should be understood, however, that the intention is not to limit the present disclosure to the embodiments described. On the contrary, the intention is to cover all modifications, equivalents, and alternatives falling within the spirit and scope of the present disclosure.

### DETAILED DESCRIPTION

Aspects of the present disclosure relate to cognitive computing. More particular aspects relate to a recommendation system configured to apply ripening pattern analytics and estimated elapsed time to provide recommendations regarding the condition of groceries (e.g., farm-produced crops and goods (hereinafter referred as produce)). A recommendation can provide a summative representation of a plurality of information. The summative representation reflects the current ripeness stage of produce, with the highest probability overlap, in consideration towards time calculated maturation and decay phases. The recommendation system can be further configured to maximize shelf life expectancy with in-home storage instructions based on historical data and additionally notify a user (e.g., consumer, shopper) when groceries have reached a desired ripeness.

Aspects of the present disclosure relate to cognitive computing and machine learning, and more specifically, cognitive food models. Cognitive food models can extrapolate data (e.g., analytics) from data sources comprising the dynamics of harvested food, growth factors, and performance data to perform growth simulations based on future events. Machine learning systems can use analytics comprising ripeness progressions of harvested groceries (e.g., fruits, vegetables) and collected sensory observations (e.g., smell, texture, shape, color), over fixed intervals of time (e.g., days, weeks, months), to accurately identify an item in advance that will achieve peak ripeness. In embodiments, an example of a machine learning and cognitive food model is the recipe service of Chef WATSON. Although not limited to such cognitive food model, an understanding of the present disclosure may be improved given the context of the cognitive food model.

Some embodiments relate to devices in the Internet of Things (IoT). The IoT can be a network of physical devices generating and sharing data. Physical devices can be, but are not limited to, information processing devices (e.g., computers, laptops, desktops), consumer devices (e.g., mobile phones, tablets, handhelds, wearables), and other devices having electronics, hardware, software, sensors, actuators, and/or network connectivity. Some embodiments further relate to natural language processing and query processing information. Processed information can be stored in a database comprised in the cloud. The cloud can perform as a network and enable shared access throughout the IoT.

At least one application of the embodiments discussed herein involves aiding users tasked with meal preparation. Users tasked with meal preparation and recipe planning can find difficulties in selecting the correct condition of produce to be used on the meal requirements. That is, depending on the condition of the produce when acquired and the amount of time between acquiring the produce and use of the produce in a recipe, the produce may not be suited for its intended use. For example, produce obtained in advance can often spoil before it is used in a recipe in which it was obtained for. As a direct result, users are either forced to change meal preparation plans or replace each spoiled item.

Advantageously, the present disclosure bridges the gap between a static list of produce items and a consumer. Selecting produce with consideration towards the amount of time it will take to achieve ripeness can ensure recipes reach their desired taste and further avoid the potential costs (e.g. time, quality, money, etc.) often incurred from obtaining produce prematurely. Aligning patterns for obtaining produce with growth patterns, produce can achieve their maximized potential shelf-life and can leave consumers more equipped with current systems being able to accurately predict the condition of the produce.

As another example advantage, aspects of the present disclosure improve the functioning of a computer by using resources more efficiently (e.g., through more accurate ripeness models and calculations) than traditional methods and reducing CPU overhead. This results in a savings of computational resources such as CPU and memory.

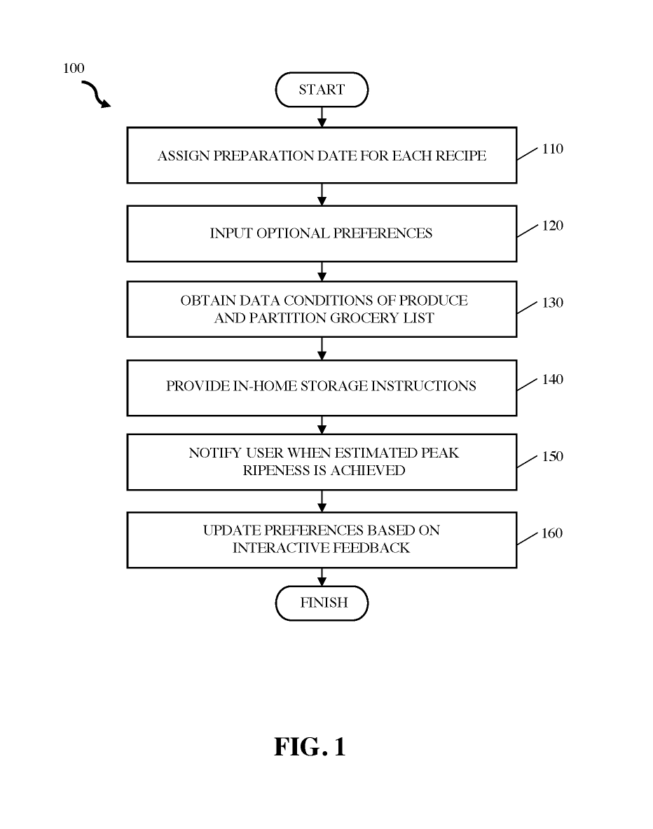

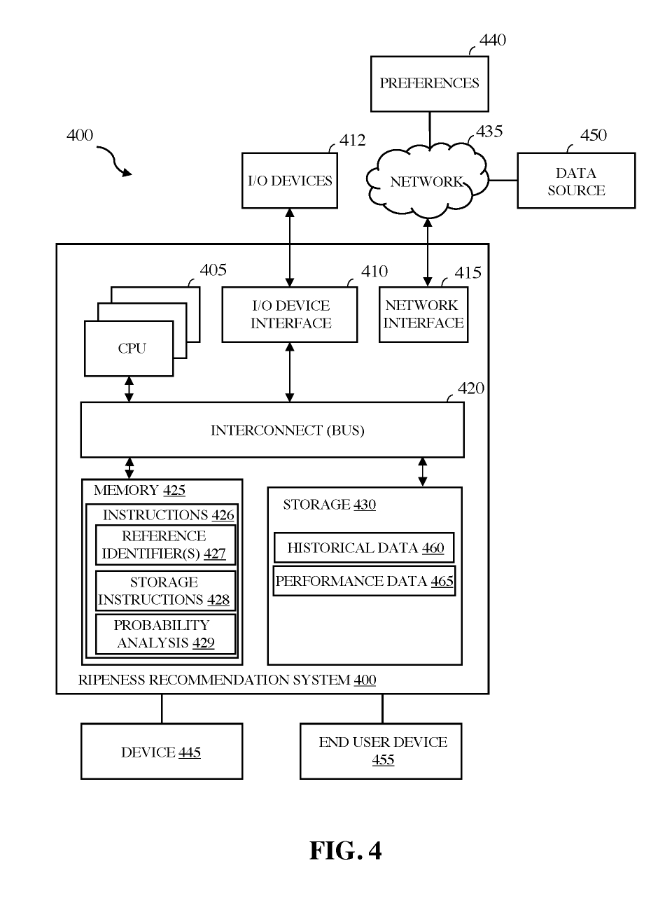

Referring now to the figures, FIG. 1 illustrates a flowchart of an example method 100 for providing recommendations based on ripening pattern recognition and time variant shelf-life projections in accordance with some embodiments of the present disclosure. The method 100 can be performed by, for example, one or more processors or a different configuration of hardware. For example, method 100 can be performed by one or more processors in system 400 in FIG. 4. In embodiments, the method 100 begins with operation 110. In operation 110, a user selects a recipe plan for a given time period (e.g. 1 week, 10 days, 1 month, etc.), inputs the intended day (e.g., Sunday or a specific date, such as, Jan. 3, 2019) to obtain produce items used in the recipes, assigns each recipe from the recipe plan to a preparation day (e.g., a specific day of the week or a specific date on a calendar), and receives a generated grocery outline of all necessary ingredients (e.g., produce, perishables, grains, meats). In some embodiments, a user can interact with existing capabilities (e.g., recipe index, cooking instructions) of online recipe service providers (e.g., Chef WATSON) to select recipe plans and generate a grocery outline. In embodiments, the grocery outline indicates the minimum number of required ingredients to recreate each recipe in the recipe plan. More specifically, the grocery outline compiles the total number of each ingredient (e.g., avocados, tomatoes, strawberries) for use and individually marks each ingredient with a number (e.g., 1-7) reflecting the number of days between the intended day to obtain the respective ingredient and assigned preparation day for each correlating recipe. For example, if the grocery outline requires three avocados, one for each of three difference recipes to be prepared on three different days, each avocado is listed with a separate number. In some embodiments, however, the system 100 is used in a mobile application which, without requiring input from the user, detects the date that the user is shopping at a grocery store and does not mark each ingredient with a number until shopping time.

Existing recipe service providers can be enhanced using the techniques described herein to improve the desired condition of each ingredient. In operation 120, the user can input additional preferences regarding the preferred condition of the compiled recipe. In embodiments, additional preferences can comprise user specific instructions (e.g., taste, temperature, serving size) as well as traditional variations of preparation methods collected from a data source comprising publically accessible data. For example, the user can indicate the ripeness and tenderness of produce to be used in the recipe. The grocery outline then partitions the required recipe ingredients by number (e.g., number 1-7 from operation 110) and pairs the additional or intended conditions previously requested by the user.

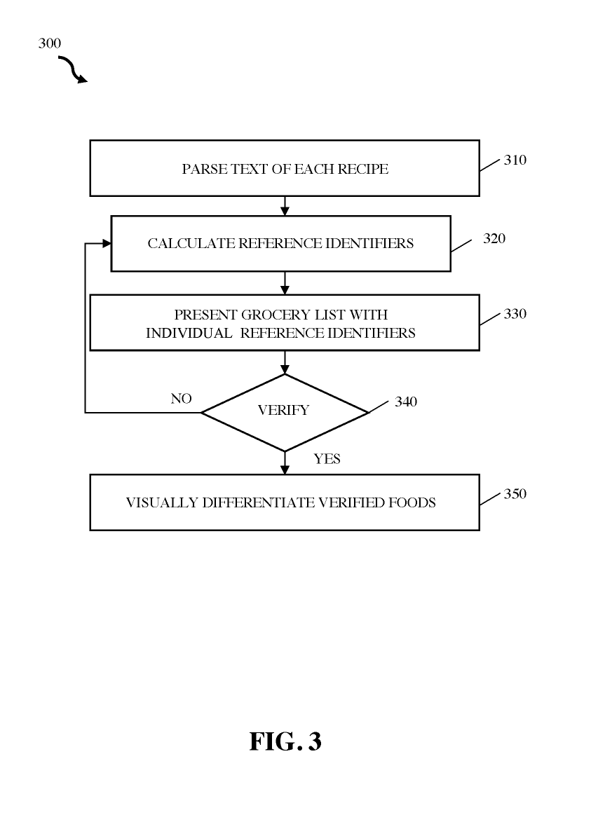

In operation 130, data conditions of produce can be collected from a plurality of data sources communicatively coupled in a network (e.g., cloud). In some embodiments, the plurality of data sources can comprise an IoT environment. Collected data can include, but is not limited to, historical data (e.g., proprietary and publicly available resources, storage methods, meal preparation tips), performance analytics (e.g., grocery produce growth models, ripening patterns, morphology) and location services (e.g., global positioning system (GPS)). Collected data can be obtained from one or more repositories comprised in a data source storage system or from components within a device (e.g., handheld, wearable). Operation 130 integrates each partition of ingredients from grocery outline in operation 120 into a grocery list and transfers the grocery list to the user's handheld (e.g., mobile device) and/or wearable (e.g., smartwatch) device and calculates a suggested reference identifier. In embodiments, reference identifiers reflect a desired condition of the produce on the intended day to obtain the produce. Furthermore, in some embodiments, while the user is at the grocery store, the system can recognize the user's location and present each item of the grocery list to the user interface based on the user's location in the grocery store. The user can then interactively verify each item has been collected. Operation 130 is described in more detail hereinafter with respect to FIG. 3.

In some embodiments, existing resources can be optionally used to further guide the user through a given store to locations of needed grocery list items. For example, using GPS capabilities, the system can infer which store a user is currently at and extract the floorplan from an external database comprising the schematic drawings and product placement in various locations.

Upon verification in operation 130, operation 140 individually prescribes in-home storage methods (e.g., wrap in foil) and placement locations (e.g., in direct sunlight) for each purchased item with consideration of each item's assigned preparation day and storage environment best suited to facilitating ripening. Ripeness levels for produce selected in operation 130 are compared to future ripeness levels of a plurality of similar food comprised in the network. Measuring the current aesthetic condition (e.g., visual appearance) and using data points (e.g., ageing coefficient) collected through calculations in operation 130, the system determines the probability an item will ripen within the threshold of allotted time. Items satisfying the threshold are given instructions based on standard preparation methods obtained from proprietary and publically available resources. Items with outlying values of maturation (e.g., below, above) are given instructions to accelerate and/or delay growth.

In operation 150, the system can estimate the expected ripeness levels of stored food and provide a notification (e.g., an indication, a warning, a message, a prompt) to a user interface that an item has achieved peak ripeness. The user interface can comprise the user's handheld device and/or smartwatch, for example. The notification can comprise text, graphics, infographics, sounds, and/or other notifications. In some embodiments, the notification includes a recommended option to prepare the food for meal preparation and, as part of the notification, requests approval.

In operation 160, the user can alter (e.g., change, modify, reconfigure, update) the system to accommodate for changes in the originally set meal preparation plan. For example, the user can decide to switch meal preparation days three and four. The system can then provide preparation updates to compensate for new feedback. The ripeness recommendation model can then suggest to prematurely move the item into a new location (e.g., refrigerator, in direct sunlight, etc.) so as to expedite or delay maturation. The user can additionally provide feedback based on successful trials for the system to incorporate.

FIG. 1 is intended to represent operations of an example method for ingredient selection in accordance with some embodiments of the present disclosure. In some embodiments, however, individual operations can have greater or lesser complexity than shown in FIG. 1, and operations in addition to (or in substitution of) those shown in FIG. 1 can be present. Furthermore, in some embodiments, various operations illustrated in FIG. 1 can have greater, lesser, or different functionality than shown in FIG. 1. Furthermore, in some embodiments, various operations illustrated in FIG. 1 can occur in different orders, if they occur at all.

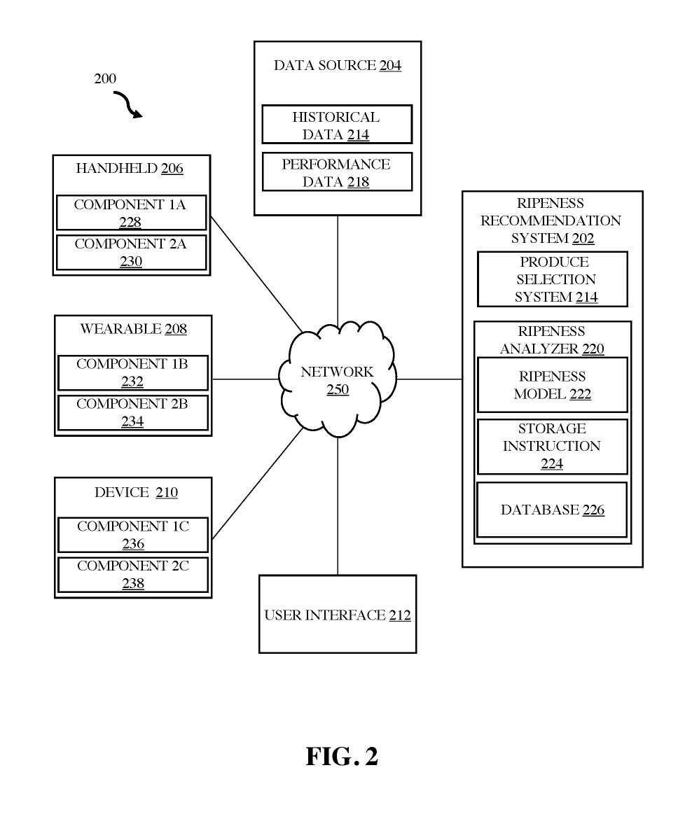

Referring now to FIG. 2, illustrated is a block diagram of an example IoT environment 200. IoT environment 200 can include numerous components communicatively coupled by a network 250 such as, but not limited to, a ripeness recommendation system 202, data sources 204, numerous devices (e.g., handheld 206, and wearable 208, device 210), and a user interface 212. In embodiments, network 250 can be comprised in the cloud.

Ripeness recommendation system 202 can include produce selection system 214. Produce selection system 214 can be configured to generate selection purchasing instructions for respective devices in IoT environment 200 based on historical data 216 and/or performance data 218 (e.g., various produce growth and decay timelines) collected from data sources 204 (e.g., external database, online resources).

Produce selection system 214 generates a reference identifier (e.g., reference identifier from operation 130 of FIG. 1) for each ingredient item compiled into the grocery list from operation 110 of FIG. 1. The reference identifier is a visual representation and recommended qualitative condition description based on, for example, visual appearance (e.g., color, gloss, shape, size, etc.), condition (e.g., absence of defects, thickness, hardness, etc.), sensory enhancement (e.g., smell, firmness, texture etc.), or other factors to establish an accurate desired condition of produce on the intended day to obtain the produce for each recipe and assigned preparation day. In various embodiments, visual and transcribed data can be generated at an instant time or for data collected in a respective time interval (e.g., based on the time duration of meal plan selection) for a respective device based on the accessibility to each device when obtaining the produce.

In some embodiments, reference identifiers are based on one or more counts of information. That is to say, in some embodiments, reference identifiers are in a format conducive to user accessibility. In some embodiments, respective reference identifiers can comprise auditory playback. In some embodiments, reference identifiers can be in a digital imaging format where pre-ripe, ripe, and projected ripe groceries are displayed on a respective device.

Ripeness recommendation system 202 can further include ripeness analyzer 220. Ripeness analyzer 220 can comprise, but is not limited to, cognitive computing and machine-learning food model. In embodiments, ripeness analyzer 220 can be configured to identify the time variation between the current state of the given produce and ripe state of produce as well as the proper way to store each item so that it is best used on the assigned preparation day. Ripeness analyzer 220 further includes ripeness model 222 (e.g., ripeness recommendation model (also referred to herein as ripeness model 222) of operation 130 in FIG. 1). In embodiments, ripeness model 222 uses produce maturation analytics obtained from data source 204 to determine the current produce ripening progression stage. Progression stages represent the condition each item of produce should resemble throughout each period of the maturation process. Items are then assigned a value score (e.g., percentage until fully ripe) and weighted against like-condition items with different preparation days. Based on percentage overlap, items are given a storage instruction 224. Storage instruction 224 (e.g., storage preparation instructions of operation 140) can be configured to use performance data 218 and prescriptive analytics to forecast (e.g., predict, project, anticipate, estimate, etc.) future ripeness levels based on alternative shelf placement locations (e.g., store in refrigerator, store in dark cabinet, store directly in sunlight). Storage instruction 224 can additionally notify the user when a selected produce has reached its projected desired ripeness. In embodiments, if a user decides to change meal preparation days, a notification can supply alternative pre-meal preparation instructions to achieve desired state (e.g., remove from refrigerator a day before if it is not soft or a desired consistency). Ripeness analyzer 220 can further include database 226. Database 226 can store extracted processing information from data source 204. In embodiments, database 226 can comprise a physical repository location or accessible in the cloud.

Ripeness recommendation system 202 can collect data from handheld 206, wearable 208, and device 210. Handheld 206 can include component 1A 228 and component 1B 230. Likewise, wearable 208 can include component 1B 232 and component 2B 234. Likewise, device 210 can include component 1C 236 and component 2C 238. Although handheld 206, wearable 208, and device 210 are each shown with two components, each device can contain more or fewer components. Although three devices are shown, embodiments exist containing more or fewer devices. Handheld 206, wearable 208, and device 210 can be similar or dissimilar IoT devices such as, but not limited to, computers, servers, vehicles, industrial equipment, infrastructure, smartphones, tablets, network components, sensors, and so on. Respective components in respective devices (e.g., components 228, 230, 232, 234, 236, and 238) can be portions of the devices generating the condition reference identifiers. For example, components can be, but are not limited to, sensors (e.g., temperature sensors, global positioning system (GPS) sensors).

Data source 204 can include historical data 216 and performance data 218. Historical data 216 can include a history of the environmental conditions for current produce items in a store as well as their expected shelf life and maturation levels. In some embodiments, historical data 116 can be used by ripeness model 222 to generate a mean (e.g., average) condition in order to determine an estimated timeline through morphology stages.

Performance data 218 can include decay and maturation data accounting for ripening patterns or condition decreases in an ingredient over time. Performance data 218 can include a mean (e.g., average) condition for an ingredient at various points in the maturation of the produce as well as predicted progression stage.

User interface 212 can convey information (e.g., notifications) from ripeness recommendation system 202 to a user (e.g., consumer). User interface 138 can convey warnings via text, graphs, infographics, sounds, etc. User interface 212 can receive input from a user such as, for example, a change in assigned preparation days.

FIG. 2 is intended to represent illustrative components of an example IoT environment 200 according to embodiments of the present disclosure. In some embodiments, however, individual components can have greater or lesser complexity than shown in FIG. 2, and components other than, or in addition to those shown in FIG. 2 can be present. Furthermore, in some embodiments, various components illustrated in FIG. 2 can have greater, lesser, or different functionality than shown in FIG. 2.

Referring now to FIG. 3, illustrated is an example method 300 for grocery list compilation and verification at a grocery store in accordance with some embodiments of the present disclosure. The method 300 can be performed by, for example, one or more processors or a different configuration of hardware. For clarity, the method 300 will hereinafter be described as being performed by the ripeness recommendation system, however, aspects of the present disclosure can be performed by other hardware components or combinations of hardware components. The method 300 begins in operation 310. In some embodiments, the method 300 may be performed as part of operation 130 of FIG. 1.

Operation 310 can be configured to parse each recipe comprised in the recipe plan by natural language processing. The recipe plan can be a recurring recipe plan, such as a weekly recurring recipe plan. Hence, for purposes of explanation, the recipe plan can be referred to herein as a weekly recipe plan. However, it is to be understood that, in other embodiments, the recipe plan is not a recurring plan, or the recipe plan can repeat at other intervals, such as, but not limited to 15 days, a month, etc.

Using parse dependency trees, semantic identifiers (e.g., food group labels) can be assigned to each required ingredient. A parse dependency tree is a hierarchical structure which represents the derivation of the grammar to yield input strings. In embodiments, semantic identifiers can comprise, but are not limited to, fruit, vegetable, protein, grain, and dairy. Operation 310 assigns each ingredient a semantic identifier and extracts non-produce items (e.g. protein, grain, dairy). Non-produce items are compiled into the generated grocery list waiting for user verification. Produce (e.g., fruit, vegetable) items are separately compiled into a query system database (e.g., database 226 of FIG. 2) and sent for further processing.

In alternate embodiments, ingredients may be repeated throughout multiple recipes in the weekly recipe plan. In instances, the system can be configured to count the total number of repeated produce compiled into the query system database. The system can further parse each recipe to determine the frequency each item has been used and provide a tally. In embodiments, for example, the system can identify the weekly recipe plan requires two avocados and three bananas. The ripeness recommendation system partitions each item and arranges the produce based on preparation day. For example, day one items are grouped together (e.g., day one avocado, day one banana), day two items are grouped together (e.g., day two banana) and day five items are grouped together (e.g., day five avocado, day five banana).

In operation 320, prior to obtaining the produce, condition performance simulations can be executed with historical data to calculate an ageing coefficient. An ageing coefficient can represent the expected growth rate of an item and can be applied to a ripeness recommendation system to determine which condition of produce has the highest probability to achieve maximum ripeness within set parameters. In embodiments, parameters can comprise the time differential between the intended day to obtain the produce and intended preparation day. The ripeness recommendation system extracts produce information from data sources, applies the ageing coefficient and ranks each condition projection with the highest probability to achieve maximum ripeness. Based on ranking, reference identifiers are created. In embodiments, reference identifiers can comprise a proposed visual (e.g., photo) and transcribed description reflecting the current condition of produce to purchase during shopping. For example, reference identifiers can explicitly describe the visual appearance (e.g., color, gloss, shape, size, etc.), condition (e.g., absence of defects, thickness, hardness, etc.), sensory enhancement (e.g., smell, firmness, texture etc.), or other factors based on historical data, to inform the user the complexity of produce to purchase based on highest probability overlap. Extracting the information from data sources, processing uses the composition make up (e.g., innocuous ingredients), manufacturing and processing step (e.g., picked), and environmental factors (e.g., post-harvest levels of ethylene, current storage temperature, humidity) to find growth analytics.

In some embodiments, alternative version of reference identifier can be created for repeated produce. For example, the system can recommend the day one avocado to comprise a soft dark green complexion with a moveable stem and the day five avocado to comprise a firm medium green complexion with a rigid stem.

Using the location services in the user's device, the system in operation 330 can determine where the user is relative to the grocery. At the grocery store, the ripeness recommendation system extracts all produce from the produce outline comprised in the database (e.g., database 226 of FIG. 2) and sends a compiled grocery list (e.g., produce and non-produce) to the user's device (e.g., handheld, wearable). In embodiments, the compiled grocery list is available via the user interface (e.g., user interface 212 of FIG. 2). Through a user initiated interactive function (e.g., auditory playback, hyperlink), the ripeness recommendation system uses the reference identifier to make a recommendation on how to select each item.

In operation 340, a user can interactively verify that each item matches the suggested recommended condition and has been obtained on the intended day to obtain the produce. In embodiments, verification can comprise swiping (e.g., left, right, top, bottom) the reference identifier to a designating side of the user interface. In embodiments, for example, the right designating side can represent verification and the left designating side can represent unsatisfactory. If the user indicates the reference identifier as unsatisfactory, the system re-performs operation 320—operation 340 with updated preferences supplemented by the user.

Upon verification, operation 350 can visually differentiate items on the user interface. In some embodiments, for example, verified items can be assigned a color text different from the text presented in operation 330 or represented with a strikethrough. Although not limited to such visually differentiation methods, the system continually updates after each verification.

FIG. 3 is intended to represent illustrative components of an example method 300 according to embodiments of the present disclosure. In some embodiments, however, individual components can have greater or lesser complexity than shown in FIG. 3, and components other than, or in addition to those shown in FIG. 3 can be present. Furthermore, in some embodiments, various components illustrated in FIG. 3 can have greater, lesser, or different functionality than shown in FIG. 3.

FIG. 4 illustrates a block diagram of an example ripeness recommendation system 400 in accordance with some embodiments of the present disclosure. In some embodiments, ripeness recommendation system 400 is configured to implement methods consistent with embodiments of method 100 of FIG. 1 and method 300 in FIG. 3.

The ripeness recommendation system 400 includes a memory 425, storage 430, an interconnect (e.g., BUS) 420, one or more CPUs 405 (also referred to as processors 405 herein), an I/O device interface 410, I/O devices 412, and a network interface 415. Memory 425 can comprise instructions 426. Instructions 425 can comprise reference identifier(s) 427, storage instruction 428, and probability analysis 429. Storage 430 can comprise historical data 460 and performance data 465. The example ripeness recommendation system 400 of FIG. 4 further includes a network interface 415 configured to couple the system 400 to a network 435. In this example, the system 400 is coupled to external data source 450 and is configured to receive user preferences 440 via network 435. Furthermore, the example system 400 of FIG. 4 is also coupled to device 445 and end user device 455. However, it is to be understood that, in other embodiments, system 400 is not coupled to one or more of network 435, device 445, external data source 450 and/or end user device 455. For example, in some embodiments, the user preferences 440 can be obtained via one or more end user devices 455.

Each CPU 405 retrieves and executes programming instructions stored in the memory 425 or storage 430. The interconnect 420 is used to move data, such as programming instructions, between the CPUs 405, I/O device interface 410, storage 430, network interface 415, and memory 425. The interconnect 420 can be implemented using one or more busses. The CPUs 405 can be a single CPU, multiple CPUs, or a single CPU having multiple processing cores in various embodiments. In some embodiments, a CPU 405 can be a digital signal processor (DSP). In some embodiments, CPU 405 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 425 is generally included to be representative of a random access memory (e.g., static random access memory (SRAM), dynamic random access memory (DRAM), or Flash). The storage 430 is generally included to be representative of the cloud or other devices connected to the recipe recommendation system 400 via the I/O devices interface 410 or a network 435 via the network interface 415. In embodiments, network 435 can be configured to perform similar to the network 250 of FIG. 2.

In some embodiments, the memory 425 stores instructions 426 and the storage 430 stores historical data 460 and performance data 465. In embodiments, storage 430 can be a repository residing on highly-replicated backend storage systems distributed geographically across a plurality of devices 445. In embodiments, the plurality of end user devices 455 can comprise wearables (e.g., smartwatches) and handhelds (e.g., mobile phones), and connected devices. Grocery items, produce descriptions, produce condition images, ripeness pattern trends and projection models are extracted from data source 450 and uploaded to historical data 460 and performance data 465. Instructions 426 initiate data collection. Instructions 426 additionally initiates instructions to generate reference identifier(s) 427, storage instructions 428, and probability analysis 429.

Reference identifier(s) 427 is configured to generate reference identifiers consistent with the reference identifier in operation 130 of FIG. 1. Storage instructions 428 can be consistent with in-home storage instructions in operation 140 of FIG. 1. Probability analysis 429 can be consistent with establishing the ageing coefficient and mapping predicted growth overlap in operation 320 of FIG. 3.

Data source 450 can comprise analytics from a plurality of produce databases and recipe service providers, such as, for example, types, trends, preparation tips, and global harvesting data to establish potential factors.

Instructions 426 are processor executable instructions including recommendations for selecting the condition of produce, considering historical data 460, performance data 465, and a time threshold of an assigned preparation day derived in method 100. Instructions 426 can be executed by ripeness recommendation system 400 to collect data from numerous devices in an IoT environment and generate recommendations based on the collected data. The purchasing recommendation is output to end user device 455.

In various embodiments, the I/O devices 412 include an interface capable of presenting information and receiving input (e.g., user interface 212 of FIG. 2).

FIG. 4 is intended to represent illustrative components of an example ripeness recommendation system 400 according to embodiments of the present disclosure. In some embodiments, however, individual components can have greater or lesser complexity than shown in FIG. 4, and components other than, or in addition to those shown in FIG. 4 can be present. Furthermore, in some embodiments, various components illustrated in FIG. 2 can have greater, lesser, or different functionality than shown in FIG. 4.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

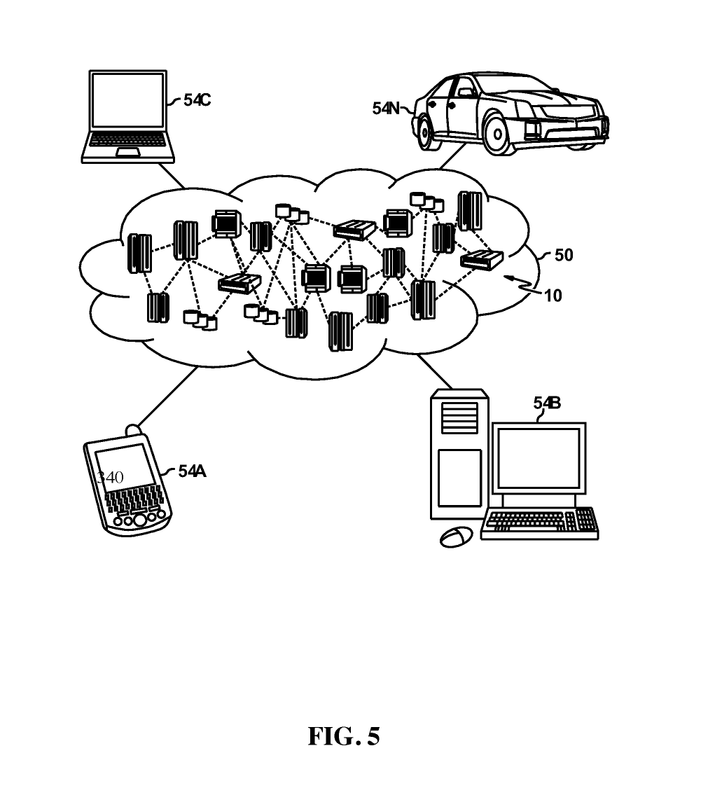

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

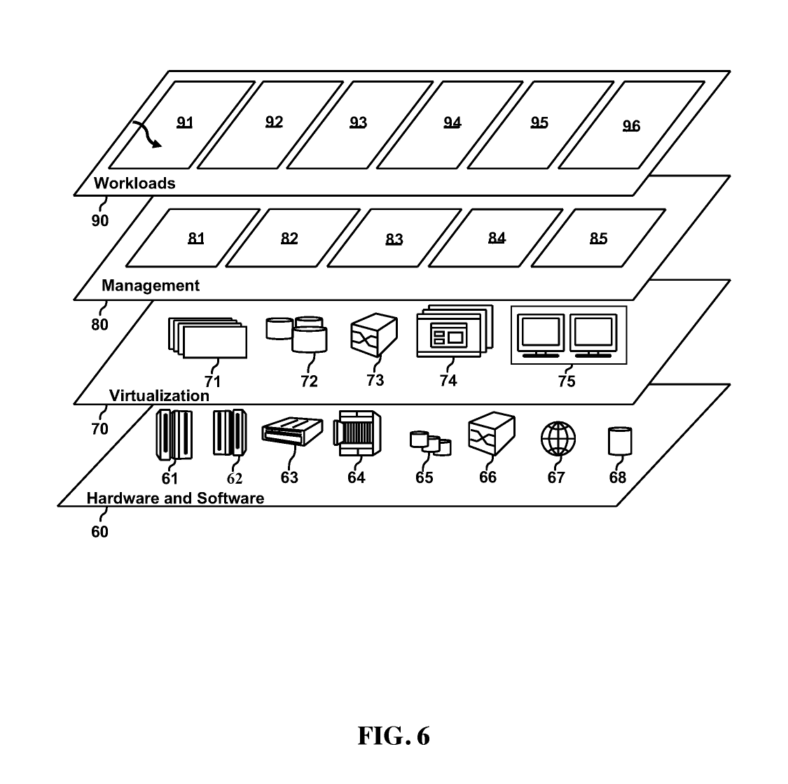

Referring now to FIG. 6, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and ripeness recommendation 96. Embodiments of the present invention may be a system, a method, and/or a computer program product at any possible technical detail level of integration. The computer program product may include a computer readable storage medium (or media having computer readable program instructions thereon for causing the processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or subset of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing, or otherwise receiving payment for use of the systems.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing produce recommendations, the method comprising:
receiving a preparation day for each recipe comprised in a plurality of selected recipes;
receiving respective preferences for a plurality of produce comprised in the plurality of selected recipes;
partitioning an interactive grocery list;
calculating respective reference identifiers for single and repeated produce items extracted from the plurality of selected recipes, wherein repeated produce items are presented with different respective reference identifiers; and
outputting the calculated reference identifiers to a user device, wherein each respective reference identifier comprises a specific visual representation and recommended qualitative description of the condition of corresponding produce that will have the highest probability to achieve ripeness considering an estimated number of days before use.

2. The method of claim 1, wherein each respective reference identifier is selected based on a corresponding highest probability condition determined from historical and performance data comprised in data sources;
wherein historical data comprises analytics relating to visual appearance, condition, sensory enhancement, compositional make up, and environmental factors;
wherein performance data comprises growth analytics relating to maturation and decay phase projections and morphology stages of produce.

3. The method of claim 1, further comprising:
outputting recommendations for in-home storage instructions for selected produce items from the plurality of selected recipes, wherein the recommendation for in-home storage instructions are selected to maximize shelf life expectancy by identifying a storage environment best suited to facilitate ripening, wherein the recommendation for in-home storage instructions comprise a method and placement location for each selected produce item with consideration towards the corresponding assigned preparation days.

4. The method of claim 1, further comprising:
outputting respective notifications to a user for the selected produce items, on or before corresponding assigned preparation days, when a respective desired ripeness is achieved for each of the selected produce items, wherein the respective notifications indicate new instructions to a user that current instructions are unsuitable for a current condition of produce to achieve a target ripeness, wherein the new instructions are created from averages in historical data and performance data, wherein the respective notifications are further updated based on the interactive feedback.

5. The method of claim 1, wherein the respective preferences comprise taste, temperature, size and traditional condition, wherein traditional conditions are selected from data sources comprising proprietary and publicly available food reference data.

6. The method of claim 1, further comprising visually differentiating on an interactive grocery list between obtained produce items and uncollected produce items based on user interaction.

7. The method of claim 1, wherein produce comprised in the plurality of selected recipes is partitioned into the interactive grocery list, wherein the interactive grocery list is transferred to a user device.

8. A system for providing produce recommendations, the system comprising:
a computer readable storage medium storing a corpus of data;
a user interface configured to receive input and present output; and
a processor communicatively coupled to the computer readable storage medium and the user interface and having a memory comprising instructions, which, when executed by the processor, cause the processor to:
receive a preparation day for each recipe comprised in a plurality of selected recipes;
receive respective preferences for a plurality of produce comprised in the plurality of selected recipes;
partition an interactive grocery list;
calculate respective reference identifiers for single and repeated produce items extracted from the plurality of selected recipes, wherein repeated produce items are presented with different respective reference identifiers; and
output the calculated reference identifiers to a user device, wherein each respective reference identifier comprises a specific visual representation and recommended qualitative description of the condition of corresponding produce that will have the highest probability to achieve ripeness considering an estimated number of days before use.

9. The system of claim 8, wherein each respective reference identifier is selected based on a corresponding highest probability condition determined from historical and performance data comprised in data sources;
wherein historical data comprises analytics relating to visual appearance, condition, sensory enhancement, compositional make up, and environmental factors; and
wherein performance data comprises growth analytics relating to maturation and decay phase projections and morphology stages of produce.

10. The system of claim 8, further comprising:
outputting recommendations for in-home storage instructions for selected produce items from the plurality of selected recipes, wherein the recommendation for in-home storage instructions are selected to maximize shelf life expectancy by identifying a storage environment best suited to facilitate ripening, wherein the recommendation for in-home storage instructions comprise a method and placement location for each selected produce item with consideration towards the corresponding assigned preparation days.

11. The system of claim 8, further comprising:
outputting respective notifications to a user for the selected produce items, on or before corresponding assigned preparation days, when a respective desired ripeness is achieved for each of the selected produce items, wherein the respective notifications indicate new instructions to a user that current instructions are unsuitable for a current condition of produce to achieve a target ripeness, wherein the new instructions are created from averages in historical data and performance data, wherein the respective notifications are further updated based on the interactive feedback.

12. The system of claim 8, wherein the respective preferences comprise taste, temperature, size and traditional condition, wherein traditional conditions are selected from data sources comprising proprietary and publicly available food reference data.

13. The system of claim 8, further comprising visually differentiating on an interactive grocery list between obtained produce items and uncollected produce items based on user interaction.

14. The system of claim 8, wherein produce comprised in the plurality of selected recipes is partitioned into a grocery list, wherein the grocery list is transferred to a user device.

15. A computer program product for providing produce recommendation, the computer program product comprising a computer readable storage medium having program instructions embodied therewith, the program instructions executable by a processor to cause the processor to:
receive a preparation day for each recipe comprised in a plurality of selected recipes;
receive respective preferences for a plurality of produce comprised in the plurality of selected recipes;
partition an interactive grocery list;
calculate respective reference identifiers for single and repeated produce items extracted from the plurality of selected recipes, wherein repeated produce items are presented with different respective reference identifiers; and
outputting the calculated reference identifiers to a user device, wherein each respective reference identifier comprises a specific visual representation and recommended qualitative description of the condition of corresponding produce that will have the highest probability to achieve ripeness considering an estimated number of days before use.

16. The computer program product of claim 15, wherein each respective reference identifier is selected based on a corresponding highest probability condition determined from historical and performance data comprised in data sources;
wherein historical data comprises analytics relating to visual appearance, condition, sensory enhancement, compositional make up, and environmental factors; and
wherein performance data comprises growth analytics relating to maturation and decay phase projections and morphology stages of produce.

17. The computer program product of claim 15 further comprising:
outputting recommendations for in-home storage instructions for selected produce items from the plurality of selected recipes, wherein the recommendation for in-home storage instructions are selected to maximize shelf life expectancy by identifying a storage environment best suited to facilitate ripening, wherein the recommendation for in-home storage instructions comprise a method and placement location for each selected produce item with consideration towards the corresponding assigned preparation days.

18. The computer program product of claim 15, further comprising:
outputting respective notifications to a user for the selected produce items, on or before corresponding assigned preparation days, when a respective desired ripeness is achieved for each of the selected produce items, wherein the respective notifications indicate new instructions to a user that current instructions are unsuitable for a current condition of produce to achieve a target ripeness, wherein the new instructions are created from averages in historical data and performance data, wherein the respective notifications are further updated based on the interactive feedback.

19. The computer program product of claim 15, herein the respective preferences comprise taste, temperature, size and traditional condition, wherein traditional conditions are selected from data sources comprising proprietary and publicly available food reference data.

20. The computer program product of claim 15, further comprising visually differentiating on an interactive grocery list between obtained produce items and uncollected produce items based on user interaction.
